(19) United States
(12) Patent Application Publication
(10) Pub. No.: US 2017/0096557 A1
(43) Pub. Date: Apr. 6, 2017

(54) POLYARYLENE SULFIDE-DERIVED RESIN COMPOSITION AND INSERT MOLDED BODY

(71) Applicant: Polyplastics Co., Ltd., Tokyo (JP)

(72) Inventors: Katsuhei OHNISHI, Fuji-shi (JP); Tatsuya KANEZUKA, Fuji-shi (JP); Sei WAKATSUKA, Fuji-shi (JP)

(73) Assignee: Polyplastics Co., Ltd., Tokyo (JP)

(21) Appl. No.: 15/128,015

(22) PCT Filed: Mar. 17, 2015
(86) PCT No.: PCT/JP2015/057901

§ 371 Date: Sep. 21, 2016

(30) Foreign Application Priority Data
Mar. 27, 2014 (JP) 2014-065678

(51) Int. Cl. C08L 81/02; B32B 27/28; B29C 47/02; B29C 45/14; B29C 45/00; B29C 47/00; B32B 15/08; B32B 27/20

(52) U.S. Cl. CPC C08L 81/02; B32B 15/08; B32B 27/286; B32B 27/20; B29C 45/14; B29C 45/0001; B29C 47/0004; B29C 47/02; C08L 2201/08; C08L 2203/20; C08L 2205/06; B32B 2250/02; B32B 2262/101; B32B 2264/104; B32B 2457/00; B32B 2605/00; B29K 2081/04

(57) ABSTRACT

A polyarylene sulfide-derived resin composition which has flowability optimal for insert molding and which can impart superior high- and low-temperature impact properties to a molded body, and an insert-molded body using the resin composition. The resin composition includes a polyarylene sulfide resin having carboxylic terminal groups, an olefin-derived copolymer, glass fibers and calcium carbonate. The weight-average molecular weight of the polyarylene sulfide resin is 15,000-40,000; as copolymerization components, the olefin-derived copolymer includes α-olefins, glycidyl esters of α,β-unsaturated acids, and acrylic esters, and the content of the copolymerization component derived from the glycidyl esters in the resin composition is 0.2-0.6 mass %. Further, the fiber diameter of the glass fibers is 9-13 μm, the average particle diameter of the calcium carbonate is 10-50 μm, and the total content of glass fibers and the calcium carbonate is 45-55 mass % of the resin composition.

### TECHNICAL FIELD

The present invention relates to a polyarylene sulfide-derived resin composition and to an insert molded article made by integrally molding with an insert member by insert molding using this polyarylene sulfide-derived resin composition.

### BACKGROUND ART

Polyarylene sulfide (hereinafter abbreviated as “PAS”) resins, represented by polyphenylene sulfide (hereinafter abbreviated as “PPS”) resin, have high heat resistance, mechanical properties, chemical resistance, dimensional stability, and flame resistance. Therefore, PAS resins have been widely used as a material for parts of electrical or electronic devices, a material for parts of vehicle devices, a material for parts of chemical devices, and the like, in particular for applications under high temperatures in usage environment.

Among the molded articles using PAS resins in various fields as mentioned above, there are many which are molded by insert molding methods. The insert molding method is a molding method in which metals, inorganic solids and the like (hereinafter, occasionally abbreviated as “metals and the like”) are embedded in resins while making the most of the properties of the resins and the material properties of the metals and the like.

The resins and the metals and the like differ extremely in their rates of expansion or contraction due to temperature change (the so-called coefficient of linear thermal expansion). As a result, if a resin portion of the molded articles is thin-walled, the molded article frequently cracks due to the temperature change immediately after the molding or cracks due to temperature changes during use, especially in the case where the metals and the like have sharp corners, and the like.

In particular, PAS resins, as described above, have high heat resistance, mechanical properties, chemical resistance, dimensional stability, and flame resistance, whereas they are poor in toughness and are fragile, and have the disadvantage that the insert molded article has low reliability for withstanding rising and falling temperature changes between high temperature and low temperature over long terms, namely, the high- and low-temperature impact property is low. On the other hand, PAS resins have the property of excellent compatibility with, for example inorganic fillers and the like. Therefore, generally, PAS resins are often used as composite materials with added inorganic fillers, and by including inorganic fillers, it is considered that the mechanical strength such as the toughness and the like can also be improved. However, when making composite materials (resin compositions) by adding inorganic fillers to PAS resins, the melt viscosity of the resin composition increases. Therefore, the flowability of the resin composition is notably reduced, and in particular, it becomes unsuitable for insert molding.

Also, recently, resins have also been employed in components in the vicinity of vehicle engines, and since the temperature changes are large in the vicinity of engines, resin compositions having more excellent high- and low-temperature impact property are required. As resin compositions possessing such an excellent high- and low-temperature impact property, various PAS resin compositions using PAS resins have been proposed. Specifically, resin compositions are known in which an olefin-derived copolymer containing an α-olefin and a glycidyl ester of an α,β-unsaturated acid as major components is combined with a PAS resin (for example, Patent Document 1), or in which an olefin-derived copolymer of ethylene and an α-olefin of at least 5 carbons is combined with a PAS resin (for example, Patent Document 2).

By using PAS-derived resin compositions such as those described in Patent Document 1 or 2, the high- and low-temperature impact property is improved, however, there is demand for resin compositions which can impart an even more excellent high- and low-temperature impact property to a molded article.

Patent Document 1: Japanese Unexamined Patent Application, Publication No. 2000-263586

Patent Document 2: Japanese Unexamined Patent Application, Publication No. 2002-179914

### DISCLOSURE OF THE INVENTION

### Problems to be Solved by the Invention

The present invention was made in order to solve the above described problems, and an object of the present invention is to provide a PAS-derived resin composition that has flowability suitable for insert molding and is capable of imparting a superior high- and low-temperature impact property to a molded article, and an insert molded article using this PAS-derived resin composition.

### Means for Solving the Problems

The present inventors have pursued diligent studies for the purpose of solving the above described problems. Consequently, the present inventors have found that in a PAS-derived resin composition comprising a PAS resin, an olefin-derived copolymer containing an α-olefin, a glycidyl ester of an α,β-unsaturated acid, and an acrylic ester, by including in this resin composition a glass fiber having a fiber diameter within a predetermined range, and calcium carbonate having an average particle diameter within a predetermined range, in a predetermined ratio, it is possible to impart an even more excellent high- and low-temperature impact property to a molded article while also having a flowability suitable for insert molding, and thus completed the present invention. More particularly, the present invention provides the following.

The first aspect of the present invention is a polyarylene sulfide-derived resin composition comprising a polyarylene sulfide resin having a carboxylic terminal group, an olefin-derived copolymer, a glass fiber, and calcium carbonate, wherein a weight-average molecular weight of the polyarylene sulfide resin is 15,000 or more and 40,000 or less, the olefin-derived copolymer comprises an α-olefin, a glycidyl ester of an α,β-unsaturated acid and an acrylic ester as copolymerization components, a content in the resin composition of a copolymerization component derived from the glycidyl ester is 0.2 mass % or more and 0.6 mass % or less, a fiber diameter of the glass fiber is 9 μm or more and 13 μm or less, an average particle diameter of the calcium carbonate is 10 μm or more and 50 μm or less, and a total content of the glass fiber and the calcium carbonate is 45 mass % or more and 55 mass % or less.

The second aspect of the present invention is a polyarylene sulfide-derived resin composition according to the first aspect, with a melt viscosity (310° C., shear rate 1000 sec⁻¹) of 80 Pa·s or more and 240 Pa·s or less.

The third aspect of the present invention is an insert molded body made by integrally molding with an insert member by insert molding, using the polyarylene sulfide-derived resin composition according to the first or second aspect.

The fourth aspect of the present invention is an insert molded body according to the third aspect, wherein the insert member is a metal.

### Effects of the Invention

According to the PAS-derived resin composition according to the present invention, it is possible to provide suitable flowability for insert molding, and to impart excellent high- and low-temperature impact property to the resultant insert molded article.

### PREFERRED MODE FOR CARRYING OUT THE INVENTION

Hereinbelow, an embodiment of the present invention will be described in detail; however, the present invention is in no way limited to the following embodiment, and can be implemented with modifications as appropriate within the scope of the object of the present invention.

### <<Polyarylene Sulfide-Derived Resin Composition>>

The polyarylene sulfide-derived resin composition (PAS-derived resin composition; below also referred to simply as “resin composition”) according to the present invention contains a polyarylene sulfide resin having a carboxylic terminal group, an olefin-derived copolymer, and a glass fiber and calcium carbonates as inorganic fillers. First of all, these essential components will be explained below.

### <Polyarylene Sulfide Resin>

The polyarylene sulfide resin used in the present invention mainly comprises —(Ar—S)— (wherein “Ar” indicates arylene groups) as the repeating units. In the present invention, a PAS resin having a generally known molecular structure may be used.

The arylene group is not particularly limited, and for example, p-phenylene group, m-phenylene group, o-phenylene group, substituted phenylene group, p,p′-diphenylene sulfone group, p,p′-biphenylene group, p,p′-diphenylene ether group, p,p′-diphenylene carbonyl group, and naphthalene group, and the like may be mentioned. Among arylene sulfide groups constituted from such arylene groups, in addition to homopolymers using the same repeating units, polymers comprising repeating units having different arylene sulfide groups depending on the application are preferable.

As the homopolymer, one having a repeating unit of p-phenylene sulfide groups as the arylene group is preferable, although this depends on the application. This is because the homopolymer with the p-phenylene sulfide group as the repeating unit has extremely high heat resistance, and exhibits high strength, high stiffness and further high dimensional stability over a wide temperature range. Molded articles with very excellent properties can be obtained by using such homopolymers.

As the copolymer, combinations of two or more different arylene sulfide groups among the arylene sulfide groups including the above described arylene groups may be used. Among these, a combination including p-phenylene sulfide groups and m-phenylene sulfide groups is preferable in view of obtaining molded articles with high properties such as heat resistance, moldability, mechanical properties, and the like. Further, the polymer preferably comprises a ratio of 70 mol % or more of the p-phenylene sulfide group, and more preferably comprises a ratio of 80 mol % or more the p-phenylene sulfide group. It should be noted that a PAS resin having phenylene sulfide groups is a PPS (polyphenylene sulfide) resin.

The PAS resin can be manufactured by conventionally known polymerization methods. In order to remove byproduct impurities and the like, a PAS resin produced by common polymerization methods is generally washed several times using water or acetone, and then with acetic acid, ammonium chloride, and the like. As a result of this, carboxylic terminal groups are included in the PAS resin terminals in a prescribed proportion.

The weight-average molecular weight (Mw) of the PAS resin used in the present invention is 15,000 or more and 40,000 or less. By making the weight-average molecular weight of the PAS resin 40,000 or less, the PAS-derived resin composition will have high flowability in a molten state when filled into a mold. Consequently, the molten resin can easily go around an insert member in a mold. Further, by setting the weight-average molecular weight of the PAS resin to 15,000 or more, it can be made to have excellent mechanical strength and moldability. Further, a more preferable range of the weight-average molecular weight of the PAS resin is 20,000 to 38,000, and by setting such a range, the resin composition will have an even more excellent balance of mechanical strength and moldability. It should be noted that the weight-average molecular weights in this specification are values obtained by measurements using the method described in the Examples.

### <Olefin-Derived Copolymer>

The olefin-derived copolymer contains an α-olefin, a glycidyl ester of an α,β-unsaturated acid, and an acrylic ester as copolymerization components. First, the essential copolymerization components will be explained.

### [α-Olefin]

Conventionally known α-olefins can be used, without particular limitations, as the α-olefin. For example, as employable α-olefins ethylene, propylene, and butylene, and the like may be mentioned. Among these α-olefins, ethylene is especially preferred. Combinations of at least two of these α-olefins can be used as well.

Inclusion of an α-olefin as a copolymerization component in the resin composition of the present invention imparts flexibility to the molded articles. Making the molded article soft by imparting flexibility contributes to the improvement of the high- and low-temperature impact property.

In the resin composition according to the present invention, the content of the copolymerization component derived from the α-olefin in this resin composition is not particularly limited, but is preferably 2 mass % or more. By incorporating 2 mass % or more of the copolymerization component derived from the α-olefin, sufficient flexibility can be imparted to the molded articles, and the high- and low-temperature impact property can be further improved.

### [Glycidyl Ester of α,β-Unsaturated Acid]

The glycidyl ester of an α,β-unsaturated acid refers to a component represented by the general formula (1) below,

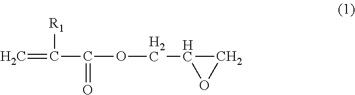

in which R₁ represents hydrogen or a lower alkyl group.

As the compounds represented by the general formula (1), for example glycidyl acrylate ester, glycidyl methacrylate ester, glycidyl ethacrylate ester and the like may be mentioned. Among these, in the resin composition according to the present invention, glycidyl methacrylate ester is preferably used.

By incorporating glycidyl esters of α,β-unsaturated acids as the copolymerization component in the resin composition of the present invention, the effect of improving the high- and low-temperature impact property of the molded article can be achieved.

In the resin composition according to the present invention, the content of the copolymerization component derived from the glycidyl ester of the α,β-unsaturated acid in this resin composition is 0.2 mass % or more and 0.6 mass % or less. If the content of the copolymerization component derived from the glycidyl ester of the α,β-unsaturated acid is less than 0.2 mass %, it is not possible to impart sufficient high- and low-temperature impact property to the molded article. On the other hand, if the content of the copolymerization component derived from the glycidyl ester of the α,β-unsaturated acid exceeds 0.6 mass %, when molding, cracked gases increase and mold deposits, which are adhesions to the mold, also increase, or gas burning occurs more readily, and it becomes impossible to effectively improve the high- and low-temperature impact property. Further, the flowability of the resin composition decreases, and it becomes unsuitable for insert molding. Moreover, it is preferable for the content of the copolymerization component derived from the glycidyl ester of the α,β-unsaturated acid in the resin composition to be within the range of 0.3 mass % to 0.6 mass %.

As the mechanism for improving the high- and low-temperature impact property in the resin composition, it is presumed that the glycidyl groups included in the copolymerization component derived from the glycidyl ester react with carboxylic terminal groups of the PAS resin, and this reaction enhances the interaction between the PAS resin and the olefin-derived copolymers, to improve the high- and low-temperature impact property. Herein, as described above, if the content of the copolymerization component derived from the glycidyl ester is too high, then the glycidyl groups of the olefin-derived copolymer react with each other, and as a result the viscosity of the resin increases and the flowability of the resin composition decreases, rendering it unsuitable for insert molding.

### [Acrylic Ester]

The acrylic ester is not particularly limited, and conventionally known ones may be used. As the employable acrylic esters, for example, methyl acrylate, ethyl acrylate, n-propyl acrylate, isopropyl acrylate, n-butyl acrylate, n-hexyl acrylate, n-octyl acrylate, and the like, as well as methacrylic acid and methacrylic acid esters, for example, methyl methacrylate, ethyl methacrylate, n-propyl methacrylate, isopropyl methacrylate, n-butyl methacrylate, isobutyl methacrylate, n-amyl methacrylate, and n-octyl methacrylate and the like may be mentioned. Among these acrylic esters, in particular, methyl acrylate is preferably used.

In the present invention, the acrylic ester is a component that, along with the copolymerization component derived from the α-olefin and the copolymerization component derived from the glycidyl ester, contributes to improving the high- and low-temperature impact property.

In the present invention, the content of the copolymerization component derived from the acrylic ester included in the olefin-derived copolymer is not particularly limited, but is preferably 10 mass % or more and 40 mass % or less. By making the content of the copolymerization component derived from the acrylic ester 10 mass % or more, excellent high- and low-temperature impact property is imparted. By making the content of the copolymerization component derived from the acrylic ester no more than 40 mass %, it is possible to maintain a high heat resistance.

### [Others]

Further, the olefin-derived copolymer can contain other copolymerization components within a scope that does not impair the effects of the present invention.

### [Production of the Olefin-Derived Copolymer]

The olefin-derived copolymer used in the present invention can be produced by polymerizing by a conventionally known method.

### [Content of the Olefin-Derived Copolymer]

In the resin composition according to the present invention, the content of the olefin-derived copolymer in the resin composition is not particularly limited, but is preferably 1 mass % or more and 8 mass % or less. Further, in the present invention, it is more important to adjust within a specific range the content of the copolymerization component derived from the above described glycidyl ester, than the content of the olefin-derived copolymer.

### <Inorganic Fillers>

### [Glass Fiber]

The resin composition according to the present invention comprises a glass fiber having a fiber diameter within a predetermined range. By including a glass fiber which is an inorganic filler with such a fiber shape, it is possible to improve the properties starting with the mechanical strength, as well as the heat resistance, dimensional stability (resistance to deformation, or warpage), electrical properties and the like, and in addition, by using a glass fiber having a fiber diameter within a predetermined range, it is possible to make the obtained molded article one having extremely excellent high- and low-temperature impact property.

From the viewpoint of improving the high- and low-temperature impact property of the molded article, it is important to include fibers with a fiber diameter within a predetermined range as described above. Specifically, the resin composition according to the present invention comprises a glass fiber with a fiber diameter of 9 μm or more and 13 μm or less. Herein, the fiber diameter of the glass fiber is the long diameter of the fiber cross section of the glass fiber.

If the fiber diameter of the glass fiber is less than 9 μm, it is not possible to impart sufficient high- and low-temperature impact property to the molded article. On the other hand, if the fiber diameter of the glass fiber exceeds 13 μm, the high- and low-temperature impact property declines. Further, the fiber diameter of the glass fiber is more preferably within a range of 9 μm to 11 μm.

As the glass fiber, the cross sectional form is not particularly limited provided that it is one having a fiber diameter within the above described predetermined range, and it is possible to use glass fibers with a circular form, elliptical form, and the like. Further, the type of the glass fiber is also not particularly limited, and for example, it is possible to use A glass, C glass, E glass and the like, and among these, it is preferable to use E glass (non-alkali glass). Further, this glass fiber may be one where a surface treatment has been applied, or one where a surface treatment has not been applied. Further, as a surface treatment for the glass fiber, treatments by means of a coating or binder which is epoxy-derived, acryl-derived, urethane-derived or the like, or treatments by means of a silane coupling agent such as aminosilane or epoxysilane or the like may be mentioned.

Further, the glass fiber is generally preferably used as chopped strands (chopped glass fibers) where bundles of a plurality of these glass fibers are cut to a predetermined length. Further, the cut length of the chopped glass fibers is not particularly limited, and for example may be on the order of 1 to 10 mm.

### [Calcium Carbonate]

The resin composition according to the present invention comprises calcium carbonate having an average particle diameter within a predetermined range. In this way, by including calcium carbonate which is a metal carbonate inorganic filler, along with the above described glass fiber, it is possible to improve the properties starting with the mechanical strength, as well as the heat resistance, dimensional stability (resistance to deformation, or warpage), and electrical properties, and in addition, by using calcium carbonate having an average particle diameter within a predetermined range, it is possible to make the obtained molded article one having extremely excellent high- and low-temperature impact property.

From the viewpoint of improving the high- and low-temperature impact property of the molded article, it is important to use a calcium carbonate with an average particle diameter within the predetermined range as described above. Further, herein, the average particle diameter indicates a particle diameter (50% d) were the integrated mass distribution becomes 50%. Specifically, the resin composition according to the present invention comprises calcium carbonate with an average particle diameter of 10 μm or more and 50 μm or less.

If the average particle diameter of the calcium carbonate is less than 10 μm, the interface between the PAS resin and the calcium carbonate becomes large. The interface becomes the origin of breakage. Therefore, it is not possible to impart sufficient high- and low-temperature impact property to the molded article. On the other hand, if the average particle size of the calcium carbonate exceeds 50 μm, the compatibility between the PAS resin and the calcium carbonate will degrade, whereby the above described mechanical strength and the like will decline and the high- and low-temperature impact property will also decline. Further, the range of the average particle diameter of the calcium carbonate is more preferably from 10 μm to 40 μm.

The calcium carbonate is not particularly limited provided that it is one having an average particle diameter within the above described predetermined range, for example, heavy calcium carbonate, precipitated calcium carbonate (light calcium carbonate, colloidal calcium carbonate) and the like may be used. Further, these calcium carbonates may be used as calcium carbonates which have been subjected to a surface treatment, for example, by fatty acids, fatty acid esters, resin acids, isocyanate compounds added with higher alcohols, and the like (surface treated calcium carbonate).

### [Content of Glass Fiber and Calcium Carbonate]

Further, in the resin composition according to the present invention, the content of the glass fiber and calcium carbonate as described above is controlled to a specific range. Specifically, the content of the glass fiber and calcium carbonate in the resin composition is such that the total content of the glass fiber and calcium carbonate is in the range of 45 mass % to 55 mass %. If the total content thereof is less than 45 mass %, the effect of improving the properties such as the mechanical strength and the like is difficult to manifest, and in addition, the high- and low-temperature impact property of the molded article declines. On the other hand, if the total content exceeds 55 mass %, the molding operation becomes difficult, and in addition, the physical properties such as the mechanical strength of the molded article and the like decline, and further, the high- and low-temperature impact property declines. Further, for the contents of the glass fiber and calcium carbonate, preferably, (content of the glass fiber)/(content of the calcium carbonate) is 1 or more and 4.5 or less.

### <Other Components>

Further, the resin composition according to the present invention may contain other resins so long as they do not impair the effects of the present invention. Further, in order to impart the desired characteristics to the molded article, for example, nucleating agents, carbon blacks, pigments such as inorganic firing pigments, antioxidants, stabilizers, plasticizers, lubricants, release agents, fire retardants or the like may be added. Resin compositions where the desired characteristics have been imparted in this way are also included within the scope of the PAS-derived resin composition used in the present invention.

### <<Preparation of the PAS-Derived Resin Composition>>

The PAS-derived resin composition according to the present invention may be prepared by a conventionally known method. Specifically, for example, any of the methods of a method in which all of the above described components are blended together, then kneading with an extruder and extruding to prepare pellets, a method in which pellets having a different temporary compositions are prepared, blending these pellets in predetermined amounts and molding, to obtain a molded article of the targeted composition after the molding, a method in which one or at least two of all of the components are directly charged into a molding machine, and the like, may be suitably used.

The resin composition according to the present invention is characterized in providing a flowability suitable for insert molding to a resin composition comprising an inorganic filler. The flowability of the resin composition varies depending on the type and blending quantity of the resin used, and in the case that the resin is a copolymer the types and proportions of the copolymerization components, and the types and blending quantities of the other additives, and the like; in the resin according to the present invention, preferable flowability can be realized primarily by adjusting the weight-average molecular weight of the PAS resin.

Specifically, as described above, the weight-average molecular weight (Mw) of the PAS resin is 15,000 or more and 40,000 or less. In a resin composition such as the one according to the present invention, even when including an inorganic filler of the above described glass fiber and calcium carbonate in the specified ratio, by adjusting the weight-average molecular weight (Mw) of the PAS resin, the resin composition becomes one having a preferable flowability, for example a melt viscosity of 80 Pa·s or more and 240 Pa·s or less at 310° C. with a shear rate of 1000 sec⁻¹.

### <<Insert Molded Article>>

The insert molded article according to the present invention is made by integrally molding with an insert member by insert molding, using the above described PAS-derived resin composition. This is similar to common insert molded articles except that the above described PAS-derived resin composition according to the present invention is employed as a material.

Herein, common insert molded articles refer to composite molded articles made by premounting a metal or the like in a mold, and filling the above mentioned PAS-derived resin composition on the outside of the metal or the like. Molding methods for filling the resin into the mold include an injection molding method, an extrusion-compression molding method and the like; the injection molding method is a standard method. In particular, in the injection molding method, such excellent flowability as in the resin composition according to the present invention is sought.

In addition, the insert member is not particularly limited; however, an insert member that is neither deformed nor melted upon contacting the resin in the course of the molding is preferably used, since the insert member is employed for the purpose of making the most of its characteristics and compensating for the drawbacks of the resin. For example, insert members that are made mainly of metals such as aluminum, magnesium, copper, iron, brass and alloys thereof, or inorganic solids such as glass and ceramics preformed into bars, pins, screws or the like are primarily used. In the present invention, the effects of the present invention are significantly manifested when using metals as the insert member. It should be noted that the insert member is not particularly restricted in shape or the like.

### EXAMPLES

Hereinbelow, the present invention will be further explained in detail with reference to Examples, but it should be understood that the present invention is not limited by the Examples.

### <<Materials>>

### [PAS Resin (A)]

PAS Resin 1 (A-1): PPS resin (weight-average molecular weight Mw: 25000), Fortron KPS W202A made by Kureha Corporation.
PAS Resin 2 (A-2): PPS resin (weight-average molecular weight Mw: 20000), Fortron KPS made by Kureha Corporation.

### (Synthesis Method of PAS Resin 2)

The synthesis method of the above described PAS resin 2 is as follows. Namely, first, 5700 g of NMP (N-methyl-2-pyrrolidone) were loaded into a 20 L autoclave, and after substitution with nitrogen gas, the temperature was increased to 100° C. over about one hour while stirring with an agitator at a rotation rate of 250 rpm. After reaching 100° C., 1170 g of an NaOH aqueous solution with a concentration of 74.7 mass %, 1990 g of a sulfur source aqueous solution (comprising NaSH=21.8 mol and Na₂S=0.5 mol) and 1000 g of NMP were added, the temperature was gradually increased to 200° C. over about 2 hours, 945 g of water, 1590 g of NMP, and 0.31 mol of hydrogen sulfide were evacuated to the outside.

Next, after the above described dehydration step, the system was cooled to 170° C., and 3524 g of p-DCB (p-dichlorobenzene), 2800 g of NMP, 133 g of water, and 23 g of NaOH with a concentration of 97 mass % were added, whereupon the temperature in the vessel became 130° C. Then, while continuously stirring with the agitator at a rotation rate of 250 rpm, the temperature was increased to 180° C. over 30 min, and further, the temperature was increased from 180° C. to 220° C. over 60 min. After reacting at this temperature for 60 min, the temperature was increased to 230° C. over 30 min, the reaction was carried out at 230° C. for 90 min, and preliminary polymerization was carried out.

Next, after the conclusion of the preliminary polymerization, the rotation rate of the agitator was immediately increased to 400 rpm, and 340 g of water was injected. After the water injection, the temperature was increased to 260° C. over 1 hr, and the final polymerization was carried out by reacting at this temperature for 5 hr. After the conclusion of the final polymerization, the reaction mixture was cooled to near room temperature, a granular polymer was recovered by sorting the contents using a 100 mesh screen, and next, washing was carried out three times with acetone, three times with water, and with 0.3% acetic acid, and after this, washing with water was carried out four times, and a washed granular polymer was obtained. The granular polymer was dried at 105° C. for 13 hr. This operation was repeated five times, and the required amount of the polymer (PPS resin 2) was obtained.

### (Measurement of the Weight-Average Molecular Weight of the PAS Resin)

Further, the measurement of the weight-average molecular weight of the PAS resin was carried out. Specifically, using 1-chloronaphthalene as the solvent, a 0.05 mass % concentration solution was prepared by heating and dissolving the resin and 1-chloronaphthalene at 230° C./10 min in an oil bath, and purifying by high temperature filtration as required. The high temperature gel permeation chromatography method (measurement device: Senshu Scientific Co., Ltd. SSC-7000; UV detector (detector wavelength: 360 nm)) was carried out, and the weight-average molecular weight was calculated by standard polystyrene conversion. The results of this calculation were that the weight-average molecular weight of the PAS resin 1 was Mw: 25000, and the weight-average molecular weight of the PAS resin 2 was Mw: 20000, as described above.

### [Olefin-Derived Copolymer (B)]

Olefin-Derived Copolymer 1 (B-1): “BONDFAST 7M” produced by Sumitomo Chemical Company, Ltd. (glycidine methacrylate (GMA) content: 6 mass %)
Olefin-Derived Copolymer 2 (B-2): “BONDFAST 7L” produced by Sumitomo Chemical Company, Ltd. (glycidine methacrylate (GMA) content: 3 mass %)
Olefin-Derived Copolymer 3 (B-3): “EVAFLEX EEA” produced by Nippon Unicar Company Limited
Olefin-Derived Copolymer 4 (B-4): “LOTADER AX8900” produced by Arkema K.K. (glycidine methacrylate (GMA) content: 8 mass %)

The olefin-derived copolymers 1, 2, and 4 contain ethylene, glycidyl methacrylate (GMA), and methyl acrylate (MA) as the copolymerization components. The olefin-derived copolymer 3 contains ethylene and ethyl acrylate as the copolymerization components. Further, in the following Tables 1 and 2, the content ratios of each of the copolymerization components (the amounts of each of the components) are shown in detail.

### [Glass Fiber (C)]

Glass Fiber 1 (C-1): “Chopped Strand ECS03T-747DE” produced by Nippon Electric Glass Co., Ltd. (fiber diameter: 6.5 μm)
Glass Fiber 2 (C-2): “Chopped Strand ECS03T-747G” produced by Nippon Electric Glass Co., Ltd. (fiber diameter: 9 μm)
Glass Fiber 3 (C-3): “Chopped Strand ECS03T-747H” produced by Nippon Electric Glass Co., Ltd. (fiber diameter: 10.5 μm)
Glass Fiber 4 (C-4): “Chopped Strand ECS03T-747” produced by Nippon Electric Glass Co., Ltd. (fiber diameter: 13 μm)
Glass Fiber 5 (C-5): “Chopped Strand ECS03T-747N” produced by Nippon Electric Glass Co., Ltd. (fiber diameter: 17 μm)

### [Calcium Carbonate (D)]

Calcium Carbonate 1 (D-1): “R Ground Calcium Carbonate” produced by Maruo Calcium Co., Ltd., average particle diameter (50% d) 7 μm
Calcium Carbonate 2 (D-2): “MC-35” produced by Asahi Kohmatsu Co., Ltd., average particle diameter (50% d) 15 μm
Calcium Carbonate 3 (D-3): “KS-500” produced by Calfine Co., Ltd., average particle diameter (50% d) 18 μm
Calcium Carbonate 4 (D-4): “FP-300” produced by Calfine Co., Ltd., average particle diameter (50% d) 27 μm
Calcium Carbonate 5 (D-5): “K-300” produced by Asahi Kohmatsu Co., Ltd., average particle diameter (50% d) 70 μm
Calcium Carbonate 6 (D-6): “A Ground Calcium Carbonate” produced by Maruo Calcium Co., Ltd., average particle diameter (50% d) 150 μm
Calcium Carbonate 7 (D-7): “Whiton P-30” produced by Toyo Fine Chemical Co.,Ltd., average particle diameter (50% d) 5 μm

### <<Resin Composition>>

For the PAS-derived resin composition, the resin composition pellets of the Examples and Comparative Examples were prepared by uniformly mixing the PAS resin, the olefin-derived copolymer, and other additives as further required, with a tumbler, a Henschel mixer or the like, and melt kneading this in a twin screw extruder with a cylinder temperature of 320° C. Further, among the composition components shown in Tables 1 and 2 below, the glass fiber and calcium carbonate were introduced into the extruder using a side feeder and melt kneaded.

### [Evaluation of the Melt Viscosity of the Resin Composition]

Herein, the melt viscosities of the resin compositions of the Examples and Comparative Examples were measured. Specifically, using a Capilograph (produced by Toyo Seiki Seisaku-sho, Ltd.), and using 1 mmφ×20 mmL/flat die as a capillary, the melt viscosity (MV) of the resin compositions was measured with a barrel temperature of 310° C. and a shear rate of 1000 sec⁻¹. The measurement results of the melt viscosity are shown in the following Tables 1 and 2.

### <<Insert Molded Article>>

Using the produced resin composition pellets of the Examples and Comparative Examples, the insert molded articles of the Examples and Comparative Examples were produced by insert injection molding with an insert metal (8 mm×23 mm×40 mm) such that the wall thickness of the resin portion was 1 mm, under the condition of a resin temperature of 320° C., a mold temperature of 150° C., an injection time of 40 sec, and a cooling time of 60 sec.

### [Evaluation of the Bending Test of the Molded Articles Using the Resin Compositions]

Using the resin compositions of the Examples and Comparative Examples, test pieces (width 10 mm, thickness 4 mmt) according to ISO 3167 were produced under the condition of a cylinder temperature of 320° C. and a mold temperature of 150° C., and the bending strain (Fγ) was measured in conformance with ISO 178. The measurement results of the bending strain are shown in the following Tables 1 and 2.

### [Evaluation of the High- and Low-Temperature Impact Property of the Insert Molded Article]

High- and low-temperature impact tests, one cycle of which consisted of the steps of heating at 140° C. for 0.5 hours, subsequent cooling at −40° C. for 0.5 hours and subsequent heating to 140° C. were performed on the insert molded articles according to the Examples and Comparative Examples using a thermal shock testing device (produced by Espec Corp.), and the number of cycles until a crack was generated in the molded article was determined, and the high- and low-temperature impact property (HS) was evaluated based on the following criteria. The evaluation results of the high- and low-temperature impact property are shown in the following Tables 1 and 2.
“A”: 200 or more cycles
“B”: 150 to less than 200 cycles
“C”: 100 to less than 150 cycles
“D”: less than 100 cycles

TABLE 1

| | | | | Examples | | | | | | | | |
|---|---|---|---|---|---|---|---|---|---|---|---|---|
| | | | | 1 | 2 | 3 | 4 | 5 | 6 | 7 | 8 | 9 |
| Content in the | (A) PAS | A-1 | | 44 | 44 | 44 | — | 44 | 44 | — | — | — |
| Resin | resin | A-2 | | — | — | — | 44 | — | — | 44 | 44 | 44 |
| Composition | (B) | B-1 | | 6 | 6 | 6 | 6 | 6 | 6 | — | — | — |
| (mass %) | Olefin- | B-2 | | — | — | — | — | — | — | — | — | — |
| | derived | B-3 | | — | — | — | — | — | — | 3 | 1.5 | — |
| | copolymer | B-4 | | — | — | — | — | — | — | 3 | 4.5 | 6 |
| | (C) Glass | C-1 | (φ6.5) | — | — | — | — | — | — | — | — | — |
| | fiber | C-2 | (φ9) | — | — | — | — | 30 | — | — | — | — |
| | | C-3 | (φ10.5) | 30 | 30 | 30 | 30 | — | — | 30 | 30 | 30 |
| | | C-4 | (φ13) | — | — | — | — | — | 30 | — | — | — |
| | | C-5 | (φ17) | — | — | — | — | — | — | — | — | — |
| | (D) | D-1 | (7 μm) | — | — | — | — | — | — | — | — | — |
| | Calcium | D-2 | (15 μm) | 20 | — | — | 20 | 20 | 20 | 20 | 20 | 20 |
| | carbonate | D-3 | (18 μm) | — | 20 | — | — | — | — | — | — | — |
| | | D-4 | (27 μm) | — | — | 20 | — | — | — | — | — | — |
| | | D-5 | (70 μm) | — | — | — | — | — | — | — | — | — |
| | | D-6 | (150 μm) | — | — | — | — | — | — | — | — | — |
| | | D-7 | (5 μm) | — | — | — | — | — | — | — | — | — |

| Amount of | Type of Olefin- | | B-1 | B-1 | B-1 | B-1 | B-1 | B-1 | B-3, | B-3, | B-4 |
|---|---|---|---|---|---|---|---|---|---|---|---|
| Respective | derived copolymer | | | | | | | | B-4 | B-4 | |
| components in | Amount of Ethylene | | 67 | 67 | 67 | 67 | 67 | 67 | 68 | 68 | 68 |
| Olefin-Derived | Amount of GMA | | 6 | 6 | 6 | 6 | 6 | 6 | 8 | 8 | 8 |
| Copolymer | Amount of MA | | 27 | 27 | 27 | 27 | 27 | 27 | 24 | 24 | 24 |
| (mass %) | | | | | | | | | | | |
| Amount of Ethylene in the Resin | | | 4.02 | 4.02 | 4.02 | 4.02 | 4.02 | 4.02 | 4.29 | 4.19 | 4.08 |
| Composition (mass %) | | | | | | | | | | | |
| Amount of the GMA in the Resin | | | 0.36 | 0.36 | 0.36 | 0.36 | 0.36 | 0.36 | 0.24 | 0.36 | 0.48 |
| Composition (mass %) | | | | | | | | | | | |
| Amount of the MA in the Resin | | | 1.62 | 1.62 | 1.62 | 1.62 | 1.62 | 1.62 | 0.72 | 1.08 | 1.44 |
| Composition (mass %) | | | | | | | | | | | |
| Evaluation | Bending Test (Fγ) | | 2.14 | 2.17 | 2.06 | 2.05 | 2.15 | 2.07 | 2.02 | 2.04 | 2.12 |
| | High- and | Number of | 271 | 290 | 210 | 164 | 230 | 190 | 167 | 204 | 260 |
| | Low- | cycles | | | | | | | | | |
| | Temperature | Evaluation | A | A | A | B | A | B | B | A | A |
| | Impact | | | | | | | | | | |
| | Property | | | | | | | | | | |

| | | | | | | | | | |
|---|---|---|---|---|---|---|---|---|---|
| Melt Viscosity (MV) | 174 | 170 | 168 | 138 | 176 | 181 | 138 | 144 | 147 |

TABLE 2

| | | | | Comparative Examples | | | | | | | | | |
|---|---|---|---|---|---|---|---|---|---|---|---|---|---|
| | | | | 1 | 2 | 3 | 4 | 5 | 6 | 7 | 8 | 9 | 10 |
| Content in the | (A) PAS | A-1 | | 44 | 44 | 44 | — | — | 44 | 44 | 44 | — | |
| Resin | resin | A-2 | | — | — | — | 44 | 44 | — | — | — | 44 | 44 |
| Composition | (B) | B-1 | | 6 | 6 | 6 | 6 | 6 | 6 | 6 | — | — | — |
| (mass %) | Olefin- | B-2 | | — | — | — | — | — | — | — | 6 | — | — |
| | derived | B-3 | | — | — | — | — | — | — | — | — | 6 | 4.5 |
| | copolymer | B-4 | | — | — | — | — | — | — | — | — | — | 1.5 |
| | (C) Glass | C-1 | (φ6.5) | — | — | — | — | — | 30 | — | — | — | — |
| | fiber | C-2 | (φ9) | — | — | — | — | — | — | — | — | — | — |
| | | C-3 | (φ10.5) | 30 | 30 | 30 | 30 | 30 | — | — | 30 | 30 | 30 |
| | | C-4 | (φ13) | — | — | — | — | — | — | — | — | — | — |
| | | C-5 | (φ17) | — | — | — | — | — | — | 30 | — | — | — |
| | (D) | D-1 | (7 μm) | 20 | — | 20 | — | — | — | — | — | — | — |
| | Calcium | D-2 | (15 μm) | — | — | — | — | — | 20 | 20 | 20 | 20 | 20 |
| | carbonate | D-3 | (18 μm) | — | — | — | — | — | — | — | — | — | — |
| | | D-4 | (27 μm) | — | — | — | — | — | — | — | — | — | — |
| | | D-5 | (70 μm) | — | — | 20 | — | 20 | — | — | — | — | — |
| | | D-6 | (150 μm) | — | 20 | — | — | — | — | — | — | — | — |
| | | D-7 | (5 μm) | — | — | — | 20 | — | — | — | — | — | — |

| Amount of | Type of Olefin- | | B-1 | B-1 | B-1 | B-1 | B-1 | B-1 | B-1 | B-2 | B-3 | B-3, |
|---|---|---|---|---|---|---|---|---|---|---|---|---|
| Respective | derived copolymer | | | | | | | | | | | B-4 |
| components in | Amount of Ethylene | | 67 | 67 | 67 | 67 | 67 | 67 | 67 | 70 | 75 | 68 |
| Olefin-Derived | Amount of GMA | | 6 | 6 | 6 | 6 | 6 | 6 | 6 | 3 | 0 | 8 |
| Copolymer | Amount of MA | | 27 | 27 | 27 | 27 | 27 | 27 | 27 | 27 | 0 | 24 |
| (mass %) | | | | | | | | | | | | |
| Amount of Ethylene in the Resin | | | 4.02 | 4.02 | 4.02 | 4.02 | 4.02 | 4.02 | 4.02 | 4.20 | 4.50 | 4.40 |
| Composition (mass %) | | | | | | | | | | | | |
| Amount of the GMA in the Resin | | | 0.36 | 0.36 | 0.36 | 0.36 | 0.36 | 0.36 | 0.36 | 0.18 | 0 | 0.12 |
| Composition (mass %) | | | | | | | | | | | | |
| Amount of the MA in the Resin | | | 1.62 | 1.62 | 1.62 | 1.62 | 1.62 | 1.62 | 1.62 | 1.62 | 0 | 0.36 |
| Composition (mass %) | | | | | | | | | | | | |
| Evaluation | Bending Test (Fγ) | | 2.06 | 1.88 | 2.05 | 1.96 | 2.00 | 2.24 | 1.97 | 1.80 | 1.86 | 1.94 |
| | High- and | Number of | 130 | 170 | 128 | 72 | 82 | 140 | 125 | 50 | 35 | 123 |
| | Low- | cycles | | | | | | | | | | |
| | Temperature | Evaluation | C | D | C | D | D | C | C | D | D | C |
| | Impact | | | | | | | | | | | |
| | Property | | | | | | | | | | | |

| | | | | | | | | | | |
|---|---|---|---|---|---|---|---|---|---|---|
| Melt Viscosity (MV) | 169 | 189 | 180 | 132 | 150 | 184 | 182 | 170 | 87 | 116 |

As is clear from the results for Examples 1 to 9 shown in Table 1, the insert molded articles produced using the PAS-derived resin compositions according to the present invention were confirmed to have mechanical strength, in addition having extremely superior high- and low-temperature impact property. Further, the resin compositions used in Examples 1 to 9 had suitable flowability for insert molding.

On the other hand, in Comparative Examples 1 to 5, the resin compositons contained calcium carbonates having respective average particle diameters of 7 μm, 150 μm, 70 μm, 5 μm, and 70 μm. For such resin compositions, it was confirmed that, compared to insert molded articles made with resin compositions comprising calcium carbonate with an average particle diameter within a range of 10 μm to 50 μm (Examples 1 to 9), the high- and low-temperature impact property declines.

Further, in Comparative Examples 6 and 7, the resin compositions comprised glass fibers having fiber diameters which were respectively 6.5 μm and 17 μm. For such resin compositions, it was also confirmed that the high- and low-temperature impact property of the insert molded article declines.

Furthermore, in Comparative Examples 8 to 10, the resin compositions respectively comprised ratios of 0.18 mass %, 0 mass %, and 0.12 mass % of the polymerization component derived from the glycidyl ester, and for such cases it was also confirmed that the high- and low-temperature impact property of the produced insert molded article declines.

1. A polyarylene sulfide-derived resin composition comprising a polyarylene sulfide resin having a carboxylic terminal group, an olefin-derived copolymer, a surface-treated glass fiber, and calcium carbonate, wherein
a weight-average molecular weight of the polyarylene sulfide resin is 15,000 or more and 40,000 or less,
the olefin-derived copolymer comprises an α-olefin, a glycidyl ester of an α,β-unsaturated acid and an acrylic ester as copolymerization components,
a content in the resin composition of a copolymerization component derived from the glycidyl ester is 0.3 mass % or more and 0.6 mass % or less,
a fiber diameter of the glass fiber is 9 μm or more and 13 μm or less,
an average particle diameter of the calcium carbonate is 10 μm or more and 50 μm or less,
a total content of the glass fiber and the calcium carbonate in the resin composition is 45 mass % or more and 55 mass % or less, and
a mass ratio that is a content of the glass fiber/a content of the calcium carbonate is 1 or more and 4.5 or less.

2. A polyarylene sulfide-derived resin composition according to claim 1, with a melt viscosity (310° C., shear rate 1000 sec⁻¹) of 80 Pa·s or more and 240 Pa·s or less.

3. An insert molded body comprising an insert member and a resin portion, wherein the resin portion comprises the polyarylene sulfide-derived resin composition according to claim 1.

4. An insert molded body according to claim 3, wherein the insert member is a metal.
